(19) United States
(12) Patent Application Publication
(10) Pub. No.: US 2010/0103685 A1
(43) Pub. Date: Apr. 29, 2010

(54) DIRECTIONAL DOWNLIGHT

(76) Inventor: Francis William Austin, Auckland (NZ)

Correspondence Address: CONNOLLY BOVE LODGE & HUTZ LLP, 1875 EYE STREET, N.W., SUITE 1100, WASHINGTON, DC, 20006, US

(21) Appl. No.: 12/444,213

(22) PCT Filed: Oct. 5, 2007
(86) PCT No.: PCT/NZ07/00291

§ 371 Date: Apr. 6, 2009

(30) Foreign Application Priority Data
Oct. 6, 2006 (NZ) 550427

(51) Int. Cl. F21V 17/02

(52) U.S. Cl. 362/366

(57) ABSTRACT

A downlight is disclosed that has an outer housing that is capable of fitting into a ceiling support structure, an inner housing resting on said outer housing and capable of rotating on said outer housing. The downlight has a frame pivotally attached to the inner housing and a lamp and reflector, each connected to the frame. The frame includes height adjustment mechanism that enables the position of one of said lamp and said reflector to be altered such that the beam of light emitted from said lamp changes in shape or intensity.

### BACKGROUND OF THE INVENTION

1. Field of the Invention

This invention relates to downlights and more particularly to downlights that are directional and capable of adjustment by a user to provide differing lighting capabilities.

2. Summary of the Prior Art

Ceiling-mounted lighting fixtures which can be recessed into the ceiling in both new construction and in retrofit situations have become useful in a variety of lighting situations due in part to the unobtrusive nature of the fixtures themselves and to the effective illumination provided by the fixtures. In new construction, recessed lighting fixtures, generally known by the term “downlights” are intended for mounting to a ceiling support structure and particularly for mounting between joists or for mounting to a grid work supporting a suspended ceiling installation.

Conventional downlights include a socket assembly electrically connected to a lamp, a trim, and a mounting plate attached to hanger bars for mounting the light in a ceiling.

### SUMMARY OF THE INVENTION

It is an object of the present invention to provide a downlight that provides the public or industry with a useful choice.

Accordingly in a first aspect the present invention consists in a downlight comprising:

an outer housing that is capable of fitting into a ceiling support structure,

an inner housing resting on said outer housing and capable of rotating on said outer housing,

a frame pivotally attached to said inner housing,

a lamp and reflector, each connected to said frame,

wherein said frame includes a height adjustment mechanism that enables the position of one of said lamp and said reflector to be altered such that the beam of light emitted from said lamp changes in shape or intensity.

Preferably the pivotal attachment between said frame and said inner housing is offset from the centre of said downlight.

Alternatively the pivotal attachment between said frame and said inner housing is substantially central to said downlight.

Preferably said inner housing has a substantially circular external circumference and a substantially elliptical inner circumference.

Preferably said frame includes a substantially elliptical base having two substantially cylindrical protrusions offset from the centre of said base.

Preferably said inner housing includes two substantially cylindrical apertures that are capable of receiving said protrusions, such that said base can be rotated within said inner housing.

Preferably said rotation of said inner housing on said outer housing is through 355 degrees.

Preferably said outer housing has a stop to prevent said inner housing rotating fully through 360 degrees.

Preferably said frame includes at least one threaded shaft fixed to a plate to which said lamp is mounted.

Preferably said at least one threaded shaft is arranged off centre from said lamp. Preferably said at least one threaded shaft is capable of being rotatably threaded through said plate, such that the rotation of said shaft causes said plate and thus said lamp to move up or down.

Preferably said height adjustment means can be actioned external to said downlight.

Preferably said external action is the rotation of a head of said shaft.

Preferably said downlight includes a tear shaped or elliptically shaped transparent cover.

Preferably said cover is attached to said shaft and due to the shaft being off centred in relation to said lamp said cover can be rotated so as to give access to said reflector and said lamp.

Preferably said reflector rests on said cover in use.

Preferably said reflector is a double parabolic cone shape.

Preferably said reflector is a double reflector having inner and outer housings.

Preferably each of said rotation of said inner housing, said pivoting of the frame and said height adjustment mechanism is controllable by a motor.

Preferably each of said motors is controlled by one of a remote controller and wireless remote.

In a second aspect the present invention consists in a lamp height adjustment mechanism for a downlight comprising:

a frame having at least one threaded shaft fixed to a plate to which at least one of a lamp and reflector is mounted, where said at least one threaded shaft is capable of being rotatably threaded through said plate, such that the rotation of said shaft causes said plate and at least one of said lamp and said reflector to move up or down such that the beam of light emitted from said lamp changes in shape or intensity.

Preferably said at least one threaded shaft is arranged off centre to said lamp.

In a third aspect the present invention consists in a downlight comprising a frame having at least one threaded shaft fixed to a plate to which at least one of a lamp and reflector is mounted, where said at least one threaded shaft is capable of being rotatably threaded through said plate, such that the rotation of said shaft causes said plate and at least one of said lamp and said reflector to move up or down such that the beam of light emitted from said lamp changes in shape or intensity.

Preferably said at least one threaded shaft is arranged off centre to said lamp.

The term “comprising” as used in the specification means “consisting at least in part of”, that is to say when interpreting statements in this invention which include that term the features prefaced by that term in each statement need to be present but other features can also be present.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### BRIEF DESCRIPTION OF THE DRAWINGS

One preferred form of the present invention will now be described with reference to the accompanying drawings.

FIG. 1 is an underneath view of a first embodiment of a downlight of the present invention.

FIG. 2 is a cross-sectional view of the downlight through AA of FIG. 1.

FIG. 3 is a plan view of the downlight of FIG. 1 when a downlight mounting strap and lamp holder mounting plate are removed.

FIG. 4 is a cross-sectional view through BB of the downlight of FIG. 3.

FIG. 5 is a plan view of the downlight of FIG. 1 when the lamp holder mounting strap is removed.

FIG. 6 is a cross-sectional view of a second embodiment of a downlight of the present invention where the downlight has a double parabolic lamp reflector.

FIG. 7 is a cross-sectional view of a second embodiment of a reflector capable of use with the downlight of the present invention, the reflector being a double skinned reflector.

FIG. 8 is a cross-sectional view of a second embodiment of a downlight of the present invention.

FIG. 9 is a second cross-sectional view of the downlight of FIG. 8.

FIG. 10 is a plan view of a downlight of a third embodiment.

FIG. 11 is a cross-sectional view through DD of the downlight of FIG. 10.

FIG. 12 is a further cross-sectional view of the downlight of FIG. 10.

### DETAILED DESCRIPTION OF THE PREFERRED EMBODIMENTS

The present invention relates to an adjustable downlight lighting fixture. In a first embodiment the downlight of the present invention is adjustable in three ways. Firstly, the downlight is adjustable such that a lamp and reflector housing is pivotable. Secondly, the downlight has a lamp and housing that can be rotated 355 degrees. Lastly, the downlight has a lamp that can be adjusted in relation to the reflector. The adjustment of the lamp is possible through external adjustment from outside the downlight housing, or without having to remove the downlight from a ceiling. However, in other forms of the downlight the height adjustment may be made alternatively, such as internally and/or only by removal of the downlight from a ceiling or fixture.

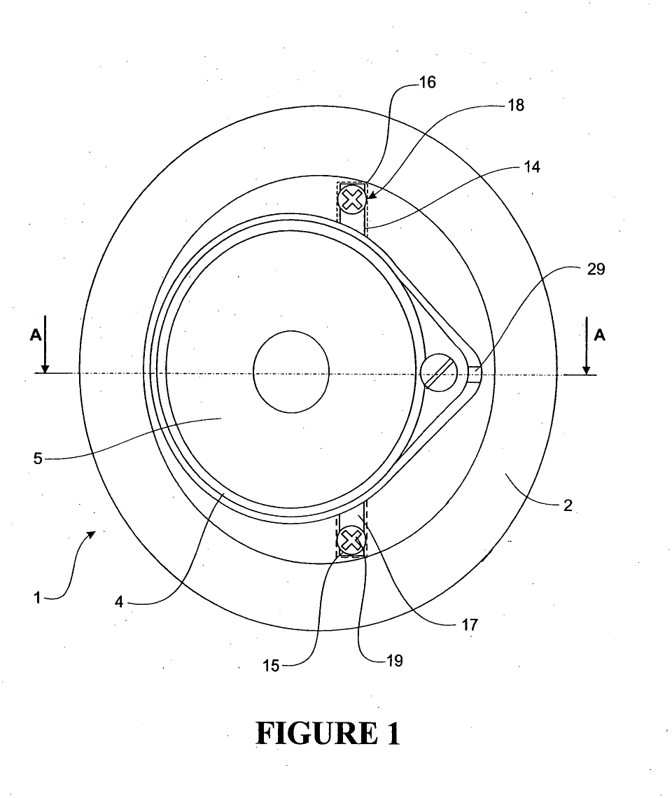

FIGS. 1 to 4 show a first preferred embodiment of a downlight of the present invention. The downlight 1 includes an outer housing 2, inner housing or mounting ring 3, a frame 13, reflector 4 and lamp 5.

The outer housing 2 is similar to the lamp fitting described in NZ Patent Number 272949 of Nimbus Lighting Group Ltd, the contents of which are incorporated herein by reference in their entirety.

The outer housing 2 of the downlight of the first embodiment is a fitting that includes a U-shaped frame 6 with legs 7, 8 having associated spring arms 9, 10, which in use, draw the fitting into engagement with the inner face of the ceiling (not shown). The base 11 of the outer housing 2 has an integral inner circumferential flange 12. The inner housing is a mounting ring 3 for the frame 13 (described below in more detail). In use the mounting ring fits within the outer housing 2 and rests on the inner flange 12. Therefore, the mounting ring 3 has an outer circumference that is circular and matches the inner circumference of the outer housing base 11. Thus the mounting ring 3 can be rotated in or on the outer housing 2 as the external surfaces of the mounting ring 3, sitting on the external surfaces (flange 12) of the outer housing, can slide over the flange 12.

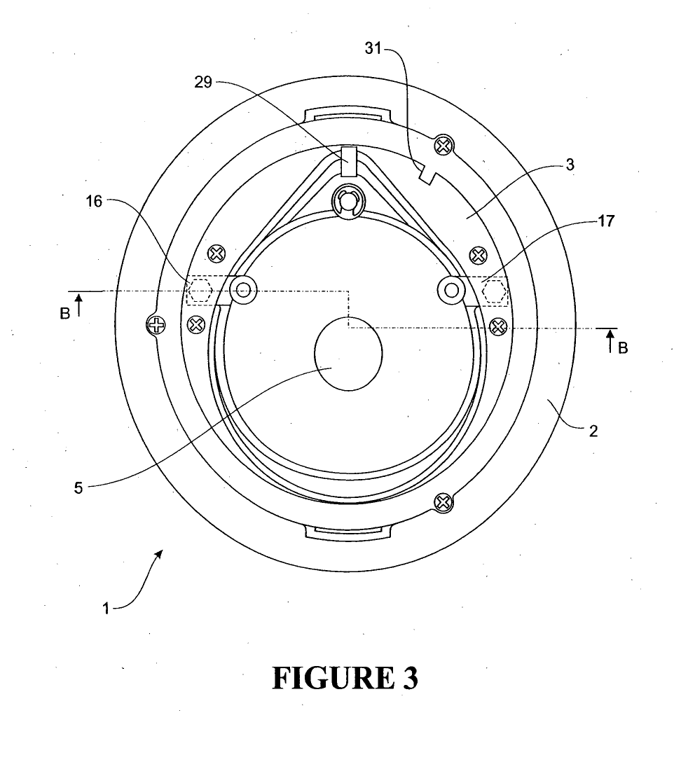

In the first embodiment the outer housing 2 has a flange 31 (see FIG. 3) that prevents the mounting ring 3 from rotating a full 360 degrees, restricting rotation to 355 degrees or similar angle.

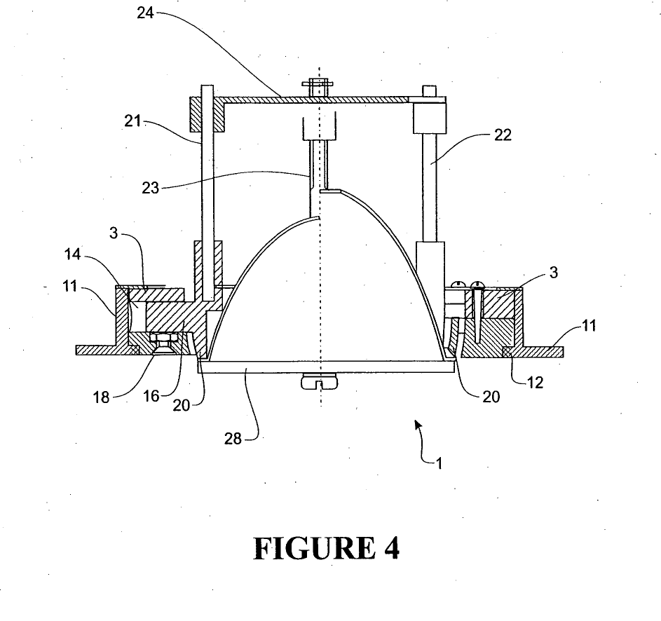

Referring to FIGS. 3 and 4, the mounting ring 3 mounts the frame within the outer housing 2. The mounting ring 3 has a substantially elliptical inner circumference and includes two opposing cylindrical recesses 14, 15. The recesses 14, 15 are off centered and receive complementary and preferably cylindrical protrusions 16, 17 on the frame 13. FIG. 4 shows one of the recesses 14 and the complementary protrusion 16 in more detail. The protrusions 16, 17 sit loosely within the recesses 14, 15 and can be rotated within the recesses to enable the frame 13 (including the lamp 5 and reflector 4) to be pivoted, in the direction shown by arrow A. This pivoting causes a change in the angular direction of the beam of light from the lamp, when the downlight and lamp is in use.

The pivoting of the frame 13 may be restricted or prevented by tightening of both or either of the screws 18, 19 that extend through the external surface of the mounting ring 3 causing the protrusions 16, 17 to be held tight between the screws and the recesses 14, 15. Thus in use a user may loosen the screws, change the angle of the frame 13 (plus lamp 5 and reflector 4). Then tighten the screws again in order for the frame 13 to be retained in the selected angular position.

The angle α that the frame 13 and thus lamp can be pivoted is restricted by the edge 27 of the cover 28 abutting against a stop flange or protrusion 29 that is integrally formed on the mounting ring 3.

In other embodiments the pivoting of the lamp and reflector may be restricted by other means, such as a cradle and flat configuration, where the substantially cylindrical protrusions 16, 17, have a flat side, such that they can be rotated within the recesses 14, 15 only one way.

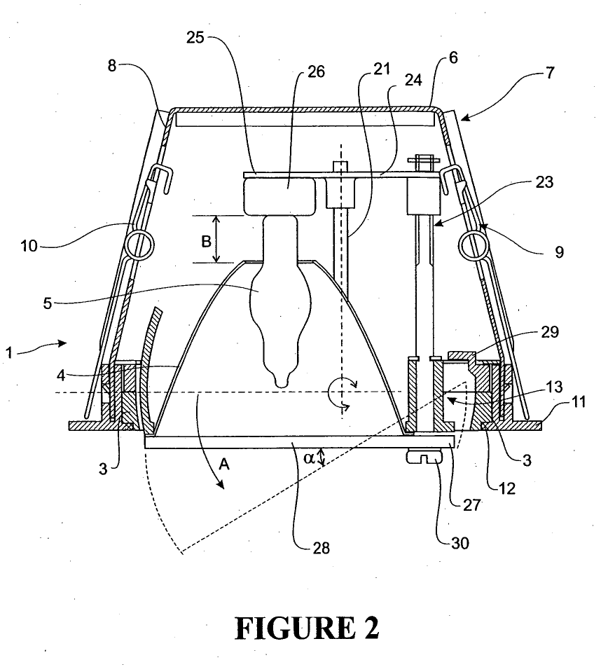

The frame 13 and the attachment of the lamp 5 and reflector 4 to the frame 13 will now be described with reference to FIGS. 2, 4 and 5. The frame 13 comprises a substantially elliptical base 20 with outwardly directed protrusions 16, 17 (described above). The protrusions 16, 17 extend from the base 20 opposite one another slightly off centre of the base 20. Extending from the base 20 near to the protrusions are two opposing guide rods 21, 22. Furthermore, a third off centred threaded shaft 23 also extends from the base 20.

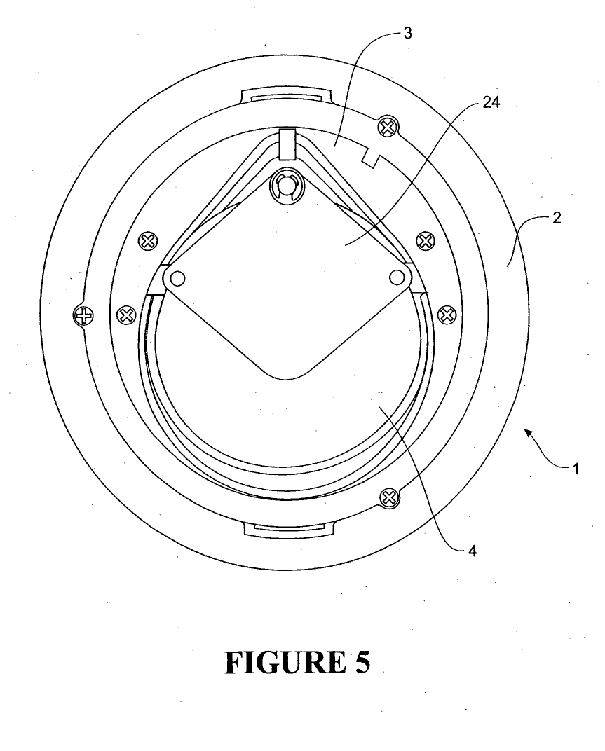

The guide rods 21; 22 and the shaft 23 form the framework (frame 13) for the mounting of the lamp 5. A mounting plate 24 (see FIG. 5 for a plan view of the plate) extends between the rods 21, 22 and shaft 23. The mounting plate 24 has three apertures that the rods and shaft extend through. The opposing rods 21, 22 are not fixed to the arm 24 but are able to move vertically through their respective apertures. The threaded shaft 23 is connected to the mounting plate by a threaded fitting.

At the end 25 of the mounting plate 24 distal to the threaded shaft 23 a lamp holder 26 is attached, by appropriate fasteners, such as glue, screws or the like, to the mounting plate 24. The lamp 5 is fitted to the holder 26 by an appropriate fitting as is known in the art, such as a bayonet or threaded fitting or pins. Appropriate electrical connections (not shown) are made to the lamp 5 through the holder 26. The height of the lamp 5 can be adjusted to provide different light beam shapes or intensities of the beam of light by rotating the shaft 23. The rotation of the shaft may be actioned by a user externally rotating the shaft head 30 causing the shaft 23 to rotate and thread through the mounting plate 24. The rotation of the shaft 23 through the mounting plate causes the mounting plate 24 and lamp 5 to move up or down, depending on the direction of rotation of the shaft head 30. An example of the extent of the change in the height “B” of the lamp 5 is shown on FIG. 2. However, the change in height will be dependent on the length of the thread on the shaft 23.

The reflector 4 may be of a simple conical shape as is known in the art. The reflector preferably merely sits in use in place between the lamp 5 and a downlight cover 28 (described in more detail below) and is not fixed to either. Therefore, if the cover 28 is rotated by 180 degrees the reflector can easily be removed from the downlight. In other embodiments the reflector may be fixed to the frame or lamp. If the reflector is fixed to the frame it can be moved up and down in the same manner as described above with references to the lamp.

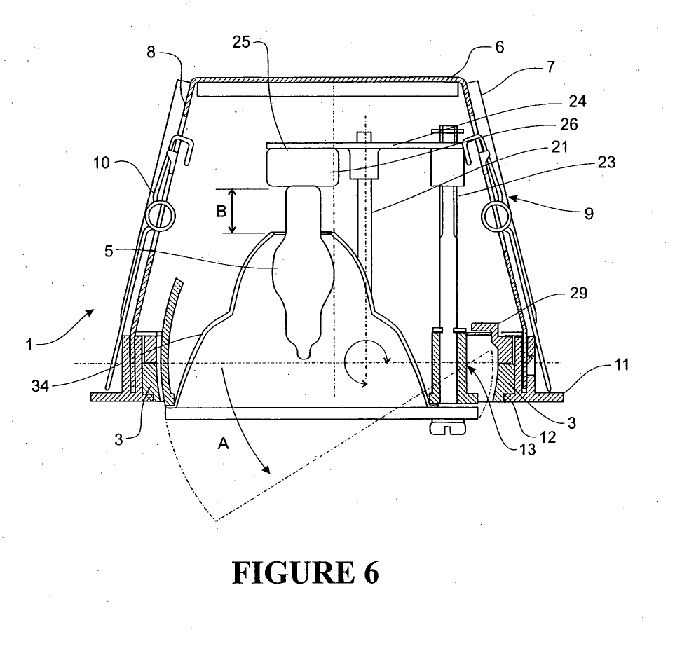

In yet other embodiments the downlight may be of have a different shaped reflector 34, such as the double parabola shaped reflector 34 shown in FIG. 6. The double parabola reflector 34 has the effect of providing additional focus of the beam of light from the lamp. Additional shaped reflectors may be provided to allow for different shaped beams, for example a triple parabolic shaped reflector.

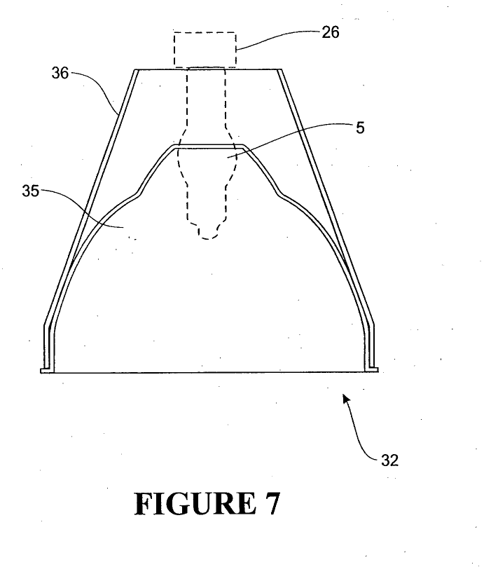

In yet a further embodiment the reflector may be of a second embodiment, a double skinned reflector, such as the reflector 32 shown in FIG. 7. This reflector 32 has an inner reflector part 35 and an outer reflector part 36. The inner reflector 35 is similar to that described above (reflector 4 or 36), however the outer reflector 36 is substantially cone shaped and extends over and above the inner reflector 35, preferably up to the lamp holder 26. The purpose of the double reflector is to prevent light leakage into the surrounding housing, to improve light stability and intensity and in the event of the lamp exploding to contain the exploded particles within the reflector 32 preventing potential fire hazards in the surrounding housing.

In any of the embodiments described it is preferred that the downlight has a cover over the lamp and reflector. However, any of the embodiments of the downlights described may not be provided with a cover. FIG. 2 shows a cover 28 fitted over the downlight 1 of the first embodiment in use. The cover 28 is made of glass, plastics or other suitable material, particularly material that at least partially allows light to travel through it. The cover 28 is tear shaped and at the apex of the tear the cover 28 is attached to the frame 13 through the shaft 23. The shaft 23 extends through a complimentary aperture in the cover 28 and is held by the shaft 23 in place. However, the cover 28 can rotate out of place, such that a user can easily access the lamp 5 and reflector 4.

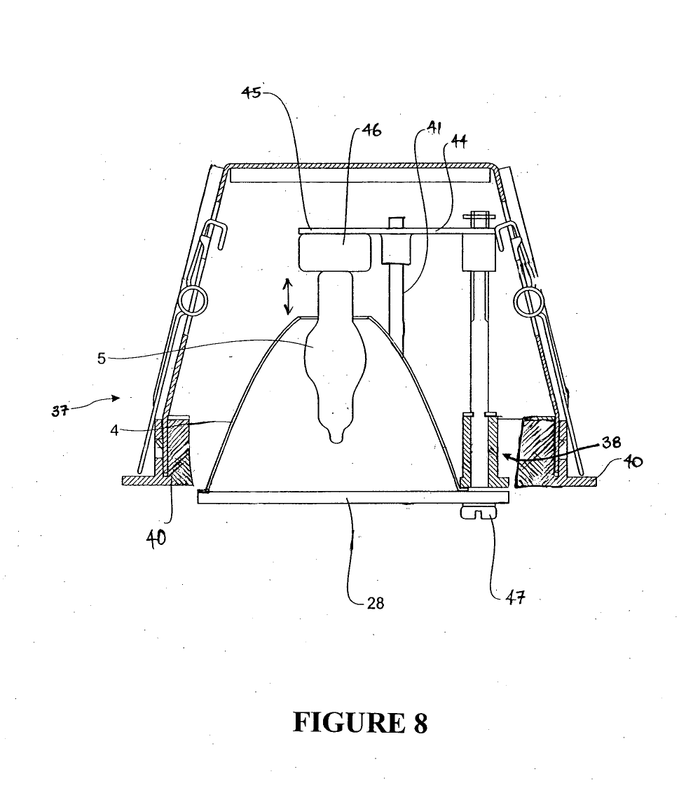

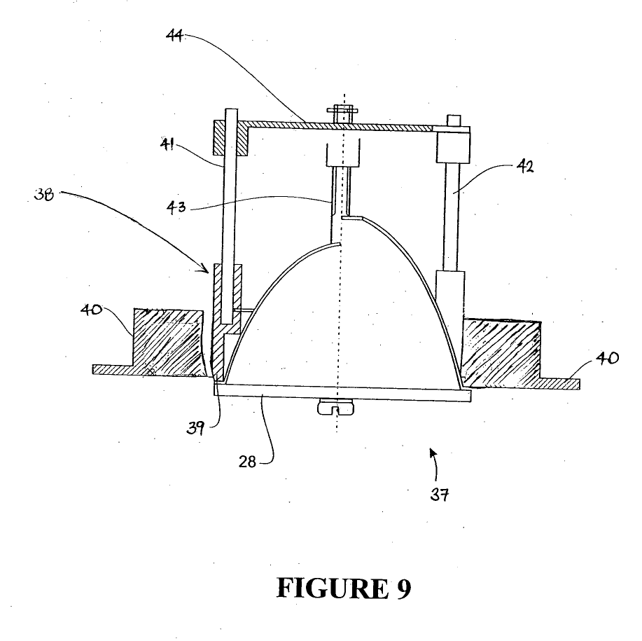

FIGS. 8 and 9 show a second embodiment of the present invention. In this embodiment the downlight 37 simply has the height adjustment mechanism but not the rotating nor pivoting mechanism of the first embodiment.

In this second embodiment, a frame 38 of the downlight 37 comprises a substantially elliptical base 39. Extending from the base 39 are two opposing guide rods 41, 42. Furthermore, a third off centred threaded shaft 43 also extends from the base 39. The frame 38 sits in use in a housing 40 that holds the downlight in place in a ceiling.

The guide rods 41, 42 and the shaft 43 form the framework (frame 38) for the mounting of the lamp 5. A mounting plate 44 extends between the rods 41, 42 and shaft 43. The mounting plate 44 has three apertures that the rods and shaft extend through. The opposing rods 41, 42 are not fixed to the plate 44 but are able to move vertically through their respective apertures. The threaded shaft 43 is connected to the mounting plate by a threaded fitting.

At the end 45 of the mounting plate 44 distal to the threaded shaft 43 a lamp holder 46 is attached, by appropriate fasteners, such as glue, screws or the like, to the mounting plate 44. The lamp 5 is fitted to the holder 46 by an appropriate fitting as is known in the art, such as a bayonet or threaded fitting or pins. Appropriate electrical connections (not shown) are made to the lamp 5 through the holder 46. The height of the lamp 5 can be adjusted to provide different light beam shapes or intensities of the beam of light by rotating the shaft 43. The rotation of the shaft may be actioned by a user externally rotating the shaft head 47 causing the shaft 23 to rotate and thread through the mounting plate 44. The rotation of the shaft 43 through the mounting plate causes the mounting plate 44 and lamp 5 to move up or down, depending on the direction of rotation of the shaft head 47. The change in height will be dependent on the length of the thread on the shaft 43.

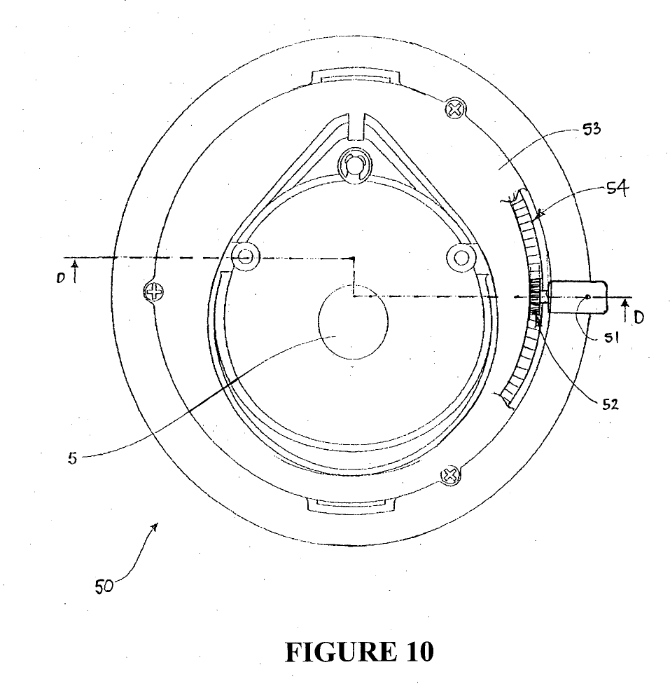

FIGS. 10 to 12 show a third embodiment of a downlight of the present invention. This downlight 50 is the same configuration and functions in a similar manner as the downlight of the first embodiment (FIGS. 1 to 4). However, the pivoting, rotation and height adjustments are controlled by motors.

In FIG. 10 a motor 51, with associated gearing 52, controls the rotation of a mounting ring 53. The gearing 52 interacts with moulded gearing 54 moulded to the mounting ring 53 in order to allow for rotation of the mounting ring 53 similar to that described above with reference to the first embodiment of the downlight.

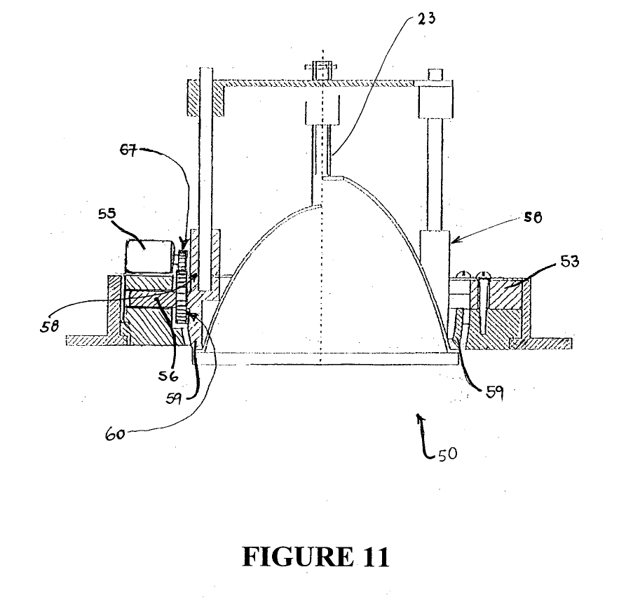

In FIG. 11 a motor 55, with associated gearing 57, controls the pivoting of a frame 58 and its elliptical base 59. The gearing 57 interacts with the gearing 60 moulded to the cylindrical pivot protrusion 56 so as to provide pivoting of the frame 13.

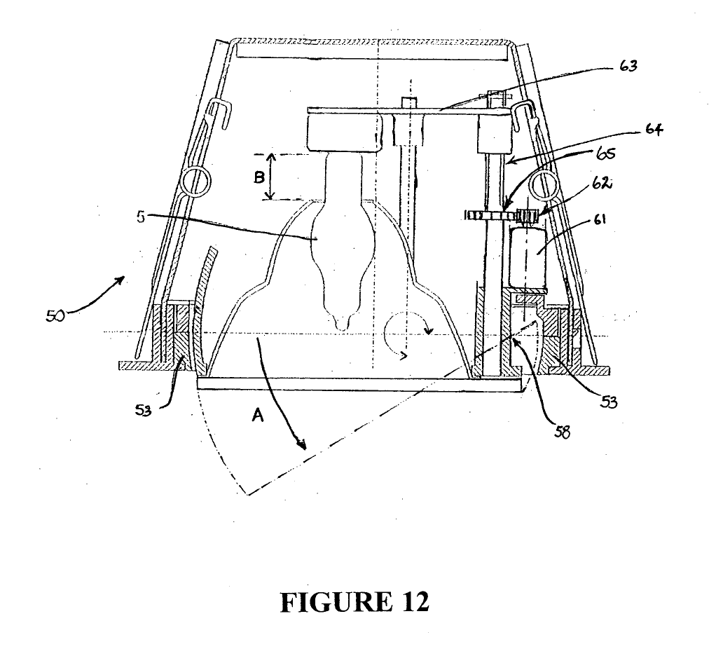

In FIG. 12 a motor 61, with associated gearing 62, controls the raising and lowering of the mounting plate 63 and thus lamp 5. Thus a shaft head (such as that head 30 of the first embodiment of the downlight) is no longer required to turn the threaded shaft 64. Mounted to the shaft 64 is a gear 65 that interacts with the motor gearing 62 so as to turn the shaft 64 one way or another in order to raise or lower the mounting plate 63 and lamp 5.

Each of the motors is preferably a low voltage motor and is controlled by a central controller that each of the motors is connected to by wiring or by wireless methods, such as infrared. The controller is connected to a user interface or panel that a user can access and adjust the downlight. Additionally or alternatively, the motors might be controlled by a wireless remote in much the same manner.

1. A downlight comprising:
an outer housing that is capable of fitting into a ceiling support structure,
an inner housing resting on said outer housing and capable of rotating on said outer housing,
a frame pivotally attached to said inner housing,
a lamp and reflector, each connected to said frame,
wherein said frame includes a height adjustment mechanism that enables the position of one of said lamp and said reflector to be altered such that the beam of light emitted from said lamp changes in shape or intensity.

2. A downlight according to claim 1 wherein the pivotal attachment between said frame and said inner housing is offset from the center of said downlight.

3. A downlight according to claim 1 wherein the pivotal attachment between said frame and said inner housing is substantially central to said downlight.

4. A downlight according to claim 1 wherein said frame includes a substantially elliptical base having two substantially cylindrical protrusions offset from the centre of said base.

5. A downlight according to claim 1 wherein said inner housing includes two substantially cylindrical apertures that are capable of receiving said protrusions, such that said base can be rotated within said inner housing.

6. A downlight according to claim 5 wherein said rotation of said inner housing on said outer housing is through 355 degrees.

7. A downlight according to claim 1 wherein said outer housing has a stop to prevent said inner housing rotating fully through 360 degrees.

8. A downlight according to claim 1 wherein said frame includes at least one threaded shaft fixed to a plate to which said lamp is mounted.

9. A downlight according to claim 8 wherein said at least one threaded shaft is arranged off center from said lamp.

10. A downlight according to claim 8 wherein said at least one threaded shaft is capable of being rotatably threaded through said plate, such that the rotation of said shaft causes said plate and said lamp to move up or down.

11. A downlight according to claim 1 wherein said height adjustment mechanism can be actioned external to said downlight.

12. A downlight according to claim 12 wherein said external action is the rotation of a head of said shaft.

13. A downlight according to claim 1 wherein said downlight includes a tear shaped or elliptically shaped transparent cover.

14. A downlight according to claim 13 wherein said cover is attached to said shaft and as said shaft is off centered in relation to said lamp said cover can be rotated so as to give access to said reflector and said lamp.

15. A downlight according to claim 13 wherein said reflector rests on said cover in use.

16. A downlight according to claim 1 wherein said reflector is a double parabolic cone shape.

17. A downlight according to claim 1 wherein said reflector is a double reflector having inner and outer housings.

18. A downlight according to claim 1 wherein each of said rotation of said inner housing, said pivoting of the frame and said height adjustment mechanism is controllable by a motor.

19. A downlight according to claim 18 where each of said motors is controlled by one of a remote controller and wireless remote.

20. A lamp height adjustment mechanism for a downlight according to claim 1 comprising:
a frame having at least one threaded shaft fixed to a plate to which at least one of a lamp and reflector is mounted, where said at least one threaded shaft is capable of being rotatably threaded through said plate, such that the rotation of said shaft causes said plate and at least one of said lamp and said reflector to move up or down such that the beam of light emitted from said lamp changes in shape or intensity.

21. A lamp height adjustment mechanism for a downlight according to claim 20 wherein said at least one threaded shaft is arranged off center to said lamp.

22. A downlight according to claim 1 comprising a frame having at least one threaded shaft fixed to a plate to which at least one of a lamp and reflector is mounted, where said at least one threaded shaft is capable of being rotatably threaded through said plate, such that the rotation of said shaft causes said plate and at least one of said lamp and said reflector to move up or down such that the beam of light emitted from said lamp changes in shape or intensity.

23. A downlight according to claim 22 wherein said at least one threaded shaft is arranged off center to said lamp.

24. (canceled)

25. (canceled)
